(19) United States
(12) Patent Application Publication
(10) Pub. No.: US 2004/0019603 A1
(43) Pub. Date: Jan. 29, 2004

(54) System and method for automatically generating condition-based activity prompts

(75) Inventors: Karen Z. Haigh, Greenfield, MN (US); Christopher W. Geib, Minneapolis, MN (US); Wende L. Dewing, Minneapolis, MN (US); Christopher A. Miller, St. Paul, MN (US); Stephen D. Whitlow, St. Louis Park, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/444,514

(22) Filed: May 23, 2003

Related U.S. Application Data
(60) Provisional application No. 60/384,519, filed on May 29, 2002.

(51) Int. Cl. G06F 17/00

(52) U.S. Cl. 707/102

(57) ABSTRACT

Embodiments of the present invention provide a system for automatically generating condition based activity prompts. The system comprises a controller and at least one sensor for monitoring an actor. The controller is adapted to receive sensor data from the sensor and determine whether to generate a condition based activity prompt based upon a comparison of the sensor data to predefined data. The condition based activity prompt is related to assisting the actor in performing a particular task, providing a reminder to the actor to perform a particular task, or providing a to-do list item to the actor.

### CROSS-REFERENCE TO RELATED APPLICATIONS

This application is related to, and is entitled to the benefit of, U.S. Provisional Patent Application Serial No. 60/384,519 filed May 29, 2002, the teachings of which are incorporated herein by reference.

### BACKGROUND OF THE INVENTION

The present invention relates to an automated system and method for generating task instructions, reminders, or To-Do lists for an actor or person responsible for the actor's well being. More particularly, it relates to a system and method that monitors the actor and/or the actor's environment, infers activities and needs of the actor and/or the actor's environment, and automatically generates intelligent task instructions or reminders.

The evolution of technology has given rise to numerous, discrete devices adapted to make daily, in-home living more convenient. For example, companies are selling microwaves that connect to the Internet, and refrigerators with computer displays, to name but a few. These and other advancements have prompted research into the feasibility of a universal home control system that not only automates operation of various devices or appliances within the home, but also monitors activities of an actor in the home and performs device control based upon the actor's activities. In other words, it may now be possible to provide coordinated, situation-aware, universal support to an in-home actor.

The potential features associated with the “intelligent” home described above are virtually limitless. By the same token, the extensive technology and logic obstacles inherent to many desired features have heretofore prevented implementation. One particular, highly desirable feature that could be incorporated into a universal in-home assistant is automatically generating and providing to-do lists, reminders, and task instructions to the actor (or others) when needed. For example, with complex tasks (or simple ones if the actor has cognitive impairments), a sequence of steps can be hard to follow, whether the task is setting time on a VCR, assembling a new bicycle, or cooking a meal. Currently, a listing of task instructions can be stored on a computer or similar device for subsequent access by an actor. However, the instructional steps are provided to the actor in a script form, and require the actor to first retrieve the task instruction set and manually toggle the scripted instructions to read the entire listing (for a relatively lengthy task). This technique is of minimal value to a person, in the midst of a particular task, who does not otherwise have quick access to the computer. Further, many persons for whom an intelligent in-home assistant system would be most beneficial are unlikely to make frequent use of a computer, and may require assistance with relatively simplistic tasks. For example, a cognitively impaired individual may, from time-to-time, need instructions for performing daily living-type tasks, such as making breakfast. To this end, that same person may not even recognize that they need task instructions. With respect to the “making breakfast” example, a cognitively impaired individual may begin their “normal” breakfast making activities by entering the kitchen and placing a teakettle on the stove, but then may forget the next step of making toast. Under these circumstances, the actor would have no way of recognizing that additional breakfast making steps were still required, and thus would not think to review a task instruction list. Thus, the current technique of requiring the actor to explicitly request task instructions and explicitly indicate that successive task steps should be displayed is simply unworkable in that there is no ability to account for the actor's activities and the context of those activities.

Similar limitations with current technology are evidenced in the area of “To-Do” lists that otherwise relate to components or elements in the actor's environment. Exemplary environmental components include furnace filter, light bulbs, battery-powered devices, medication supply, etc. A “To-Do” list associated with one or more of these components would thus include replacing the furnace filter every three months, etc. Current technology allows actors to manually enter the To-Do list items into an electronic database (e.g., PalmPilot®) for later reference and “checking off” once complete. However, these devices cannot in and of themselves generate “To-Do” entries, or automatically remove an entry upon completion because they do not monitor or take into account the current status of the environmental components of interest. That is to say, for example, a PalmPilot® cannot independently determine that a light bulb has burned out because the PalmPilot® does not monitor lights in the house. Similarly, a PalmPilot® has no way of noting that a new “To-Do” item (the installing of a new lightbulb) should be put on the list, or of automatically confirming that a new light bulb has been provided. Along these same lines, current reminder-type systems are limited to predetermined schedules provided by the user, and cannot take into account what the user is actually doing before providing a reminder. As a result, reminders may be missed, may be provided when otherwise not necessary or inappropriate, and do not have a mechanism for recognizing when a reminder should be re-presented to the actor. Once again, these limitations are a direct result of an inability to monitor and understand current activities of the actor and the actor's environment.

Emerging sensing and automation technology represents an exciting opportunity to develop an independent in-home assistant system. In this regard, a highly desirable feature associated with such a device is an ability to automatically generate intelligent reminders, To-Do lists, and task instructions for the actor (or others) utilizing the system. Unfortunately, current techniques for providing reminder or instructional-type information to an actor are unable to account for or utilize information relating to what the actor is actually doing or what is occurring in the actor's environment. Therefore, a need exists for a system and method for generating condition-based activity prompts to an actor or an actor's caregiver based upon sensed and inferred activities and needs of the actor.

### SUMMARY OF THE INVENTION

Embodiments of the present invention provide a system for automatically generating condition based activity prompts. The system comprises a controller and at least one sensor for monitoring an actor. The controller is adapted to receive sensor data from the sensor and determine whether to generate a condition based activity prompt based upon a comparison of the sensor data to predefined data. The condition based activity prompt is related to assisting the actor in performing a particular task, providing a reminder to the actor to perform a particular task, or providing a to-do list item to the actor.

### BRIEF DESCRIPTION OF THE DRAWINGS

FIG. 1 is a block diagram illustrating a system of the present invention;

FIG. 2 is a block diagram of preferred modules associated with a controller of the system of FIG. 1;

FIGS. 3A and 3B provide an exemplary method of operation of a task instruction module of FIG. 2 in flow diagram form;

FIG. 4 provide an exemplary method of operation of a To-Do list module of FIG. 2 in flow diagram form; and

FIG. 5 provides an exemplary method of operation of a personal reminder module of FIG. 2 in flow diagram form.

### DETAILED DESCRIPTION OF THE PREFERRED EMBODIMENTS

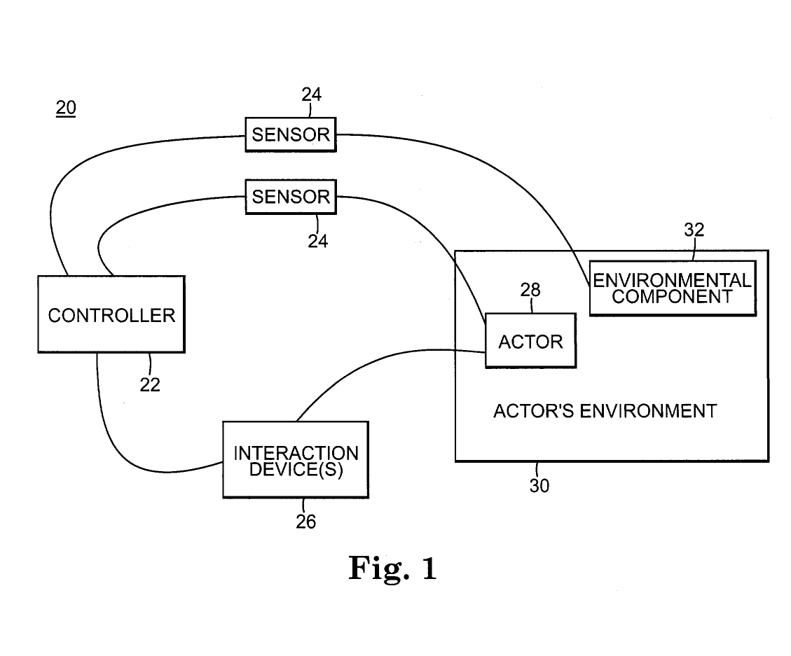

One preferred embodiment of an activity prompting system 20 in accordance with the present invention is shown in block form in FIG. 1. In most general terms, the system 20 includes a controller 22, a plurality of sensors 24, and one or more interaction device(s) 26. As described in greater detail below, the sensors 24 actively, passively, or interactively monitor activities of an actor or user 28, as well as segments of the actor's environment 30, such as one or more specified environmental components 32. Information or data from the sensors 24 is signaled to the controller 22. The controller 22 processes the received information and, in conjunction with preferred modules or system features described below, infers the need for providing to-do list items, instructions or reminders to the actor 28. Based upon this inferred need, the controller 22 signals the interaction device 26 that in turn provides or prompts the determined instruction or reminder to the actor 28 or any other interested party depending upon the particular situation.

The key component associated with the system 20 resides in the modules associated with the controller 22. As such, the sensors 24 and the interaction device 26 can assume a wide variety of forms. Preferably, the sensors 24 are networked by the controller 22. The sensors 24 can be non-intrusive or intrusive, active or passive, wired or wireless, physiological or physical. In short, the sensors 24 can include any type of sensor that provides information relating to the activities of the actor 28 or other information relating to the actor's environment 30, including the environmental component 32. For example, the sensors 24 can include medication caddy, light level sensors, “smart” refrigerators, water flow sensors, motion detectors, pressure pads, door latch sensors, panic buttons, toilet-flush sensors, microphones, cameras, fall-sensors, door sensors, heart rate monitor sensors, blood pressure monitor sensors, glucose monitor sensors, moisture sensors, etc. In addition, one or more of the sensors 24 can be a sensor or actuator associated with a device or appliance used by the actor 28, such as a stove, oven, television, telephone, security pad, medication dispenser, thermostat, etc., with the sensor or actuator providing data indicating that the device or appliance is being operated by the actor 28 (or someone else).

Similarly, the interaction devices 26 can also assume a wide variety of forms. Examples of applicable interaction devices 26 include computers, displays, keyboards, webpads, telephones, pagers, speaker systems, lighting systems, etc. The interaction devices 26 can be placed within the actor's environment 30, and/or can be remote from the actor 28, providing information to other persons concerned with the actor's 28 daily activities (e.g., caregiver, family members, etc.). For example, the interaction device 26 can be a speaker system positioned in the actor's 28 kitchen that audibly provides instructional or reminder information to the actor 28. Alternatively, and/or in addition, the interaction device 26 can be a computer located at the office of a caregiver for the actor 28 that reports to-do or reminder information (e.g., a need to refill a particular medication prescription).

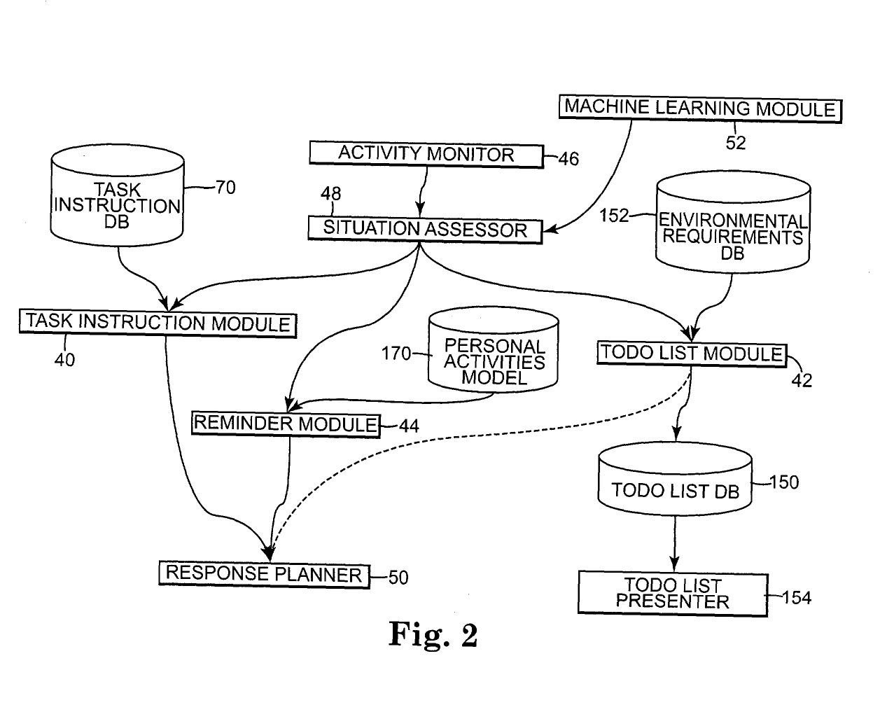

The controller 22 is preferably a microprocessor-based device capable of storing and operating preferred modules illustrated in FIG. 2. In particular, and in one preferred embodiment, the controller 22 maintains and operates a task instruction module 40, a To-Do list module 42, and a personal reminder module 44. Notably, only one or two of the modules 40-44 need be provided. As described below, the modules 40-44 each preferably make use of, or incorporate, an activity monitor 46, a situation assessor 48, and a response planner 50. Finally, in a preferred embodiment, the controller 22 includes a machine learning module 52 that assists in optimizing or adapting functioning of one or more of the components 40-50. As described in greater detail below, each of the components 40-52, can be provided as individual agents or software modules designed around fulfilling the designated function. Alternatively, one or more of the components 40-52, can instead be a grouping and inter-working of several individual modules or components that, when operated by the controller 22, serve to accomplish the designated function. Even further, separate modules can be provided for individual subject matters that internally include the ability to perform one or more of the task instruction module 40, To-Do list module 42 or personal reminder module 44 functions. For example, a “toileting” agent could be provided that keeps track of when its time to clean the toilet (similar to the To-Do list module 42), reminders to flush (similar to the personal reminder module 44) and instructions relating to toilet repair (similar to the task module 40).

Functioning of the various modules 40-44 is described in greater detail below. In general terms, the activity monitor 46 receives and processes information signaled from the sensors 24 (FIG. 1). The situation assessor 48 evaluates processed information from the activity monitor 46 and determines or infers what the actor 28 is doing and/or is intending to do, as well as what is happening in the actor's environment 30. Based upon information generated by the situation assessor 48 (and possibly information from other components), the modules 40-44 determine what action, if any, needs to be taken. For example, the task instruction module 40 decides whether a task instruction should be issued to the actor 28, preferably based upon not only inferred difficulties of the actor 28 in completing a task, but also upon the current context of the actor 28 and/or the actor's environment 30. The To-Do list module 42 decides whether to generate a To-Do list item (in an appropriate database, directly to the actor/or person, or both), with this decision preferably being context-based. The personal reminder module 44 decides whether to issue or suppress a reminder and the most appropriate presentation of a reminder, with these decisions again preferably being context-based. Regardless of the particular module 40-44, the so-determined “decision” is forwarded to the response planner 40 that determines the manner in which the decision should be implemented (e.g., which interaction device 26 to use, how to present a message, etc.).

Operation of each of the modules 40-44 is described below. From a conceptual standpoint, functioning of each of the modules 40-44 is most easily understood by referring to the situation assessor 48 as being a component(s) apart from the modules 40-44. Actual implementation, however, will preferably entail the modules 40-44 being provided as part of the situation assessor 48 (and perhaps other architectural components such as intent inference and/or other modules such as an intent recognition module). Details on preferred implementation techniques are provided, for example, in U.S. Provisional Application Serial No. 60/368,307, filed Mar. 28, 2002 and entitled “System and Method for Automated Monitoring, Recognizing, Supporting, and Responding to the Behavior of an Actor,” the teachings of which are incorporated herein by reference. For purposes of this disclosure, however, the modules 40-44 are described as individual components, and the situation assessor 48 is described as a separate component that provides different information relative to each of the modules 40-44.

A. Task Instruction Module 40

With the above in mind, in one preferred embodiment, the task interaction module 40 interacts with the situation assessor 48 and the response planner 50, as well as a task instruction database 70. In general terms, the situation assessor 48 receives information from the activity monitor 46 and determines the current state of the actor's environment 30, including what the actor 28 is doing (in addition, preferably determines what the actor 28 intends to do or the actor's 28 goals). The task instruction module 40 reviews the state information generated by the situation assessor 48 and determines/designates whether or not the actor 28 has initiated a particular task and/or evaluates the progress of the actor 28 in performing the various steps associated with the particular task. In this regard, the task instruction module 40 can arrive at this determination by reference to specific task-related information provided by the task instruction database 70 or by a more abstract technique. The task instruction module 40 then determines or infers whether the actor 28 is experiencing difficulties in completing a particular task, or otherwise requires instructional assistance. Alternatively, or in addition, the need for task-based instructions can be triggered by environment and/or time-based events. Based upon a context of the actor 28 and the environment 30, the task instruction module 40 decides whether an instruction should be issued. Where requested, the response planner 40 effectuates presentation of the task instruction.

The task instruction database 70 is preferably formatted along the lines of a plan library and includes a listing of instructional steps for a variety of tasks that are otherwise normally performed by, or of interest to, the actor 28. Thus, the types of tasks stored in the task instruction database 70, as well as the specific details associated with each instructional step, are actor-dependent, and can vary from installation to installation. For example, where the actor 28 in question suffers from cognitive impairments, the types of tasks stored in the task instruction database 70 can be relatively simplistic, such as how to make breakfast, take a shower, etc. Conversely, the task subject matter can be more complex such as setting a VCR, preparing an elaborate meal, etc. Regardless, the tasks stored in the task instruction database 70 are selected by or for the actor 28 depending upon the actor's 28 needs. The instructional steps associated with each task are likewise recorded into the task instruction database 70 by or for the actor 28. For example, where the actor 28 suffers from cognitive impairments, a caregiver or installer of the system 20 can enter the specific instructional steps associated with each task of interest. Further, the various tasks stored in the task instruction database 70 are preferably coded to a specific monitor sensor/action sequence/behavior that otherwise identifies that the actor 28 is engaged in a particular task, as well as for each individual instructional step. Once again, the particular activities relating to a particular task will be situation/installation dependent. Alternatively, the task and/or instructional step identification information otherwise provided with the task instruction database 70 can be described at a higher level of abstraction, such as in terms of recognized action/behaviors/needs. Regardless, the coded information provides a means for the task instruction module 40 to determine that a particular task, for which instructional information is stored in the task instruction database 70, is being (or will be) engaged by the actor 28.

In one preferred embodiment, the task instruction module 40 and/or the situation assessor 48 incorporates, or receives information from, the machine learning module 52 that otherwise provides a means for on-going adaptation and improvement of the system 20, and in particular, the types of tasks stored in the task instruction database 70 as well as particular instructional steps associated with discrete tasks. The machine learning module 52 preferably entails a behavior model built over time for the actor 28 and/or the actor's environment 30. In general terms, the model is built by accumulating passive (or sensor supplied) data and/or active (actor and/or caregiver entered) data in an appropriate database. The data can be simply stored “as is”, or a probabilistic evaluation of the data can be performed for deriving frequency of event series. Based upon the modeled information, the task instruction module 40 can consider adding or altering tasks or instructional steps. Learning the previous success or failure of a chosen plan or action enables continuous improvement. For example, by referencing the machine learning module 52, the task instruction module 40 can “update” the task instruction database 70 with additional tasks that the actor 28 is having difficulties with, add detail to individual instructional steps, add additional instructional steps, etc. Notably, however, the machine learning module 52 is not a necessary requirement for operation of the task instruction module 40.

As previously described, the task instruction module 40 compares current state/activity information for the actor 28, as generated by the situation assessor 48, with tasks stored in the task instruction database 70 to determine whether the actor 28 has initiated, or will initiate, performance of a particular task for which the task instruction database 70 has relevant instructional step information. Alternatively, the situation assessor 48 can make this determination apart from the task instruction module 40. In either case, the task instruction module 40 is adapted to confirm completion of each individual instructional step associated with a particular task by reference to/comparison of the individual instructional steps stored in the task instruction database 70 and the actor's 28 activities as determined by the situation assessor 48. The assessment provided by the task instruction module 40 can be performed at a variety of levels, depending upon the complexity of the particular installation. Once again, the task instruction module 40 can simply compare specific monitored sensor/action sequence or behavior information provided by the situation assessor 48 (via the activity monitor 46) with pre-determined sequence information associated with each task stored in the task instruction database 70. Alternatively, recognized action/behavior/needs (rather than sensor triggers) can be tied to each individual task, with the situation assessor 48 determining or recognizing the action/behavior/need of the actor 28. In this regard, in one preferred embodiment, the situation assessor 48 preferably includes an intent recognition module or component, that, in conjunction with intent recognition libraries, pools multiple sensed events and infers goals of the actor 28, or more simply, formulates “what is the actor trying to do”. For example, going into the kitchen, opening the refrigerator, and turning on the stove, likely indicates that the actor 28 is preparing a meal. Alternatively, intent recognition evaluations include inferring that the actor is leaving the house, going to bed, etc. In general terms, the preferred intent recognition module entails repeatedly generating a set of possible intended goals (or activities) by the actor 28 for a particular observed event or action, with each “new” set of possible intended goals being based upon an extension of the observed sequence of actions with hypothesized unobserved actions consistent with the observed actions. A probability distribution over the set of hypotheses of goals and plans implicated by each “new” set is then utilized to formulate a resultant intent recognition or inference of the actor. The library of plans that describe the behavior of the actor (upon which the intent recognition is based) is provided to the situation assessor 48 and in turn the task instruction module 40.

Regardless of how the task instruction 40 and/or the situation assessor 48 determines that the actor 28 is engaged in a particular task that is otherwise included in the task instruction database 70, the task instruction module 40 is adapted to determine whether the actor 28 is experiencing difficulties in completing a particular task and whether instructional steps should be provided.. In this regard, the task instruction module 40 can be actively or passively prompted to initiate the providing of instructions to the actor 28. For example, the task instruction module 40 can be prompted directly by the actor 28 via the user interaction device 26 (FIG. 1) (e.g., a touch pad entry, audible request from the actor 28, etc.).

Alternatively, the task instruction module 40 can review the actor's 28 activities (by the situation assessor 48) to evaluate whether the actor 28 is experiencing difficulties with the task. In a preferred embodiment, the task instruction module 40 is adapted to continually compare the actor's 28 activities with the task steps in the task instruction database 70, confirming completion of each consecutive task step such that the task instruction module 40 always “knows” how far along the actor 28 is in completing a particular task. Based upon this knowledge, the task instruction module 40 can infer actor difficulties. For example, the task instruction module 40 can be adapted to designate that a delay in excess of a predetermined length of time in completing a particular task step is indicative of “difficulties”, and thus that the actor 28 needs assistance in the form of instruction (e.g., the “task” is taking a shower, and the particular task step is placing a wet towel in a hamper after exiting the shower; where a pressure sensor associated with the hamper does not signal an increased pressure (otherwise indicative of the wet towel being placed in the hamper) within one minute of exiting the shower (as indicated, for example, by a sensor on the shower door), the task instruction module 40 will infer that the actor 28 has forgotten the step). With this or other higher level of abstraction evaluation, the task instruction module 40 preferably incorporates, or receives information from, the machine learning module 52 to optimize the analysis and evaluation of whether the actor 28 is experiencing difficulties (e.g., with continued reference to the previous example, a machine learning-built model of behavior designates that the actor 28 normally removes items from the bathroom hamper every Wednesday; where the extended delay in noting placement of a wet towel in the hamper occurs on a Wednesday, the task instruction module 40 can, based upon the learned model, determine that the actor 28 is not experiencing difficulties in completing the “place towel in hamper” step but instead is skipping this step and removing the wet towel, along with all other hamper items, from the bathroom).

Once a determination has been made that the actor is experiencing difficulties in completing a particular task step, the task instruction module 40 is adapted to determine whether instruction(s) should be issued. This decision is preferably based upon a determined context (as generated by the situation assessor 48) of the actor 28 and the actor's environment 30. For example, where the situation assessor 48 indicates that a caregiver is in the room with the actor 28 and is otherwise assisting the actor 28 with a particular task, the task instruction need not be provided. Similarly, if the situation assessor 48 indicates that the actor 28 is late for an appointment and is thus in a hurry, the task instruction module 40 can determine that the actor 28 is purposefully not completing all task steps such that task step instructions are inappropriate. Alternatively, the task instruction module 40 can be adapted to always provide instructional step information once the determination is made that the actor 28 has engaged in a particular task.

A decision by the task instruction module 40 to issue a task step instruction to the actor 28 is provided to the response planner 50. The response planner 50 is adapted to generate an appropriate response plan (i.e., presentation of instructional information), such as what to do or whom to talk to, how to present the devised response, and on what particular interaction device(s) 26 (FIG. 1) the response should be effectuated. In a preferred embodiment, the response planner 50 incorporates an adaptive interaction generation feature, that, with reference to the machine learning module allows planned responses to, over time, adapt to how the actor 28 (or others) responds to a particular planned strategy. Finally, the response planner 50, either alone or via prompting of a separate module or agent, delivers the instructional information to the actor 28. In this regard, the response planner 50 (or additional execution module) can potentially incorporate multiple levels of “politeness”. At the most polite, where the system 20 does not want to appear as if it is a reminder system, it can be formatted to pose innocuous questions to the actor 28, as opposed to a specific statement of an instruction (e.g., asking the actor 28 “Are you having tea this morning?” as opposed to saying “The next step is to place the tea kettle on the stove.”).

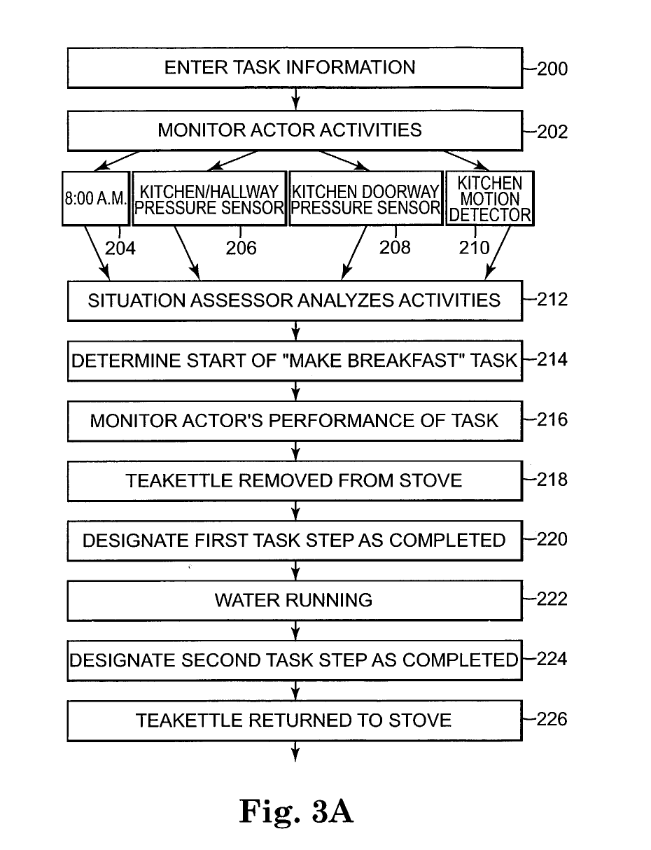

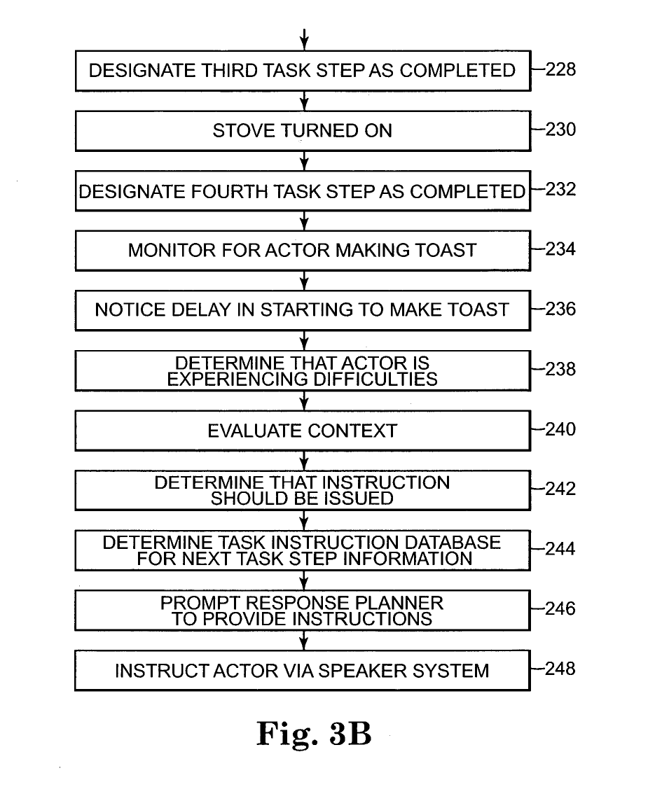

Operation of the task instruction module 40 is exemplified by the methodology described with reference to the flow diagram of FIGS. 3A and 3B. The exemplary methodology of FIGS. 3A and 3B relates to a scenario in which the system 20 is installed for an actor having cognitive impairments and thus may experience difficulties in relatively simple tasks, including making breakfast, and assumes a number of situation-specific variables.

Beginning at step 200, following installation of the system 20, an installer inputs information about the actor 28, and in particular certain tasks and related task instructional steps into the task instruction database 70. Included in these tasks is the task of making breakfast, whereby the actor 28 enjoys tea and toast. The stored steps associated with this task are first, removing a teakettle from the stove; second, filling the teakettle with water; third, returning the filled teakettle to the stove; fourth, turning the stove on; and fifth, placing bread in the toaster to make toast. With the one embodiment of FIGS. 3A and 3B, the database 70 is further written to note that the actor 28 generally eats breakfast at approximately 8:00 a.m. Notably, this same information could be generated by the machine learning module 52 and added to the “make breakfast” task in the task instruction database 70.

At step 202, the activity monitor 46 monitors activity and events of the actor 28 and in the actor's environment 30. For example, the activity monitor notes that at 8:05 a.m. (step 204), a pressure pad sensor in the actor's hallway at the kitchen door is “fired”, followed by a pressure pad sensor in the kitchen (steps 206 and 210, respectively). Finally, at step 210, the activity monitor 46 notes activity or motion in the kitchen via motion sensors.

The situation assessor 48, at step 212, analyzes the various activity information provided at steps 204-210 to determine what the actor 28 is doing and what is happening in the environment. This information is then used by the task instruction module 40 and/or the situation assessor 48 to determine whether the actor has begun, or is engaged in, a task for which instructional steps are stored in the task instruction database 70. In one preferred embodiment, this evaluation entails comparing the variously sensed activities with pre-written identifier information stored in the task instruction database 70 and otherwise coded to the “make breakfast” task. Alternatively, a higher level of abstraction evaluation can be performed. Regardless, at step 214, the task instruction module 40 and/or the situation assessor 72 determines that the actor 28 is going to begin making breakfast (or the “make breakfast” task).

With the one embodiment of FIGS. 3A and 3B, the task module 40 does not immediately begin providing instructional step information to the actor 28. Instead, the task instruction module 40 monitors the actor's 28 activities (via the situation assessor 48) as the “make breakfast” task is being performed (referenced generally at step 216). For example, at step 218, the task instruction module 40 determines, via information from the situation assessor 48, that a weight has been taken off of the stove (otherwise indicative of a teakettle being removed from the stove). The task instruction module 40 designates that this is indicative of completion of the first “make breakfast” task step, at step 220. Subsequently, water flow is noted at step 222. The task instruction module 40 denotes that the second “make breakfast” task step has been completed at step 224. This is followed by, at step 226, a weight being placed on the stove (otherwise indicative of the teakettle being placed on the stove). The task instruction module 40 confirms completion of the third task step at step 228. Finally, the stove is activated at step 230. The task instruction module 40, at step 232, denotes completion of the fourth task step.

At step 234, the task instruction module 40 awaits completion of the next “make breakfast” task step of making toast. At step 236, the task instruction module 40 notes that three minutes have passed since the stove was activated, during which time no other activities have been sensed. At step 238, the task instruction module 40 infers that this delay is indicative of the actor 28 experiencing difficulties in performing or recalling the next “make breakfast” task step. The task instruction module 40, at step 240, evaluates a current context of the actor 28 and the environment 30 as provided by the situation assessor 48. With the one example of FIGS. 3A and 3B, the determined context entails no other persons in the environment 30, no extraneous constraints on the actor's 28 schedule, or any other factors that would otherwise render providing instructions to the actor 28 inappropriate. As such, at step 242, the task instruction module 40 determines that an instruction should be issued to the actor 28. The task instruction module 40 determines the content of the instruction by referencing the step information in the task instruction database 70 at step 244.

The response planner 50 is prompted, at step 236, to generate an appropriate presentation of the designated instructional step (“make toast”) to the actor 28. At step 248, the response planner 50 prompts a kitchen speaker system (or separate speaker system control device) to announce “Please make toast.” (or similar reminder).

It will be recognized that the above scenario is but one example of how the methodology made available with the task instruction module 40 of the present invention can monitor, recognize, and provide instructional steps to the actor 28 in daily life. The “facts” associated with the above scenario can be vastly different from application to application; and a multitude of completely different daily encounters or tasks can be processed and acted upon in accordance with the present invention.

B. To-Do List Module 42

Returning to FIG. 2, the To-Do list module 42 is similar to the task instruction module 40 in that automated To-Do lists (similar to task instructions) are generated and provided to the actor based upon the sensed and inferred actions, behaviors, and needs of the actor. In one preferred embodiment, the To-Do list module 42 interacts with the situation assessor 48 and the response planner 50, as well as a To-Do list database 150, an environmental requirements database 152, and a To-Do list presenter 154.

In general terms, the situation assessor 48 receives information from the activity monitor 46 and determines the current state of the actor's environment 30, including available environmental components 32. The To-Do list module 42 reviews the state information generated by the situation assessor 48 and determines whether there are deviations from expected conditions, based upon a comparison of the current state with information in environmental requirements database 152. If a deviation is identified, the To-Do list module 42 enters a corresponding action item (to otherwise address the noted deficiency) into the To-Do list database 150, the contents of which are available to the actor 28 and/or others. In a preferred embodiment, the contents of the To-Do list database 150 are “permanently” on display to the actor 28 and/or others via the To-Do list presenter 154. In one preferred embodiment, the To-Do list module 42 is adapted to signal the response planner 50 in the event a determination is made that an identified environmental deviation requires more immediate attention. Finally, the To-Do list module 42 is adapted to monitor a status of the various items included in the To-Do list database 150, and, via information from the situation assessor 48, designate when a particular To-Do list item has been completed.

The To-Do list database 150 electronically stores one or more tasks or activities that must be carried out to maintain the actor's 28 environment 30 (FIG. 1) or the actor 28 himself/herself. The To-Do list database 150 represents the basic schedule of things the actor 28 (or others concerned with the actor's 28 well being) needs to attend to on a daily, weekly, monthly etc., basis. For example, the To-Do list database 150 can include scheduled maintenance activities, such as quarterly furnace filter replacement, weekly grocery shopping, etc. The information stored in the To-Do list database 150 can be entered by the actor 28 or others such as the actor's caregiver, the system installer, etc., and/or generated by the To-Do list module 42 (or other components of the system 20).

The environmental requirements database 152, on the other hand, stores general needs, constraints and expectations of the actor's environment 30 that are not otherwise specifically listed in the To-Do list database 150. The information associated with the environmental requirements database 152 is generally unpredictable, and can include a constraint such as all light bulbs must be operational, depleted batteries should be replaced, nearly empty pill bottles should be re-filled, etc. In this regard, the environmental requirements can be referenced or entered generally by the actor 28 (or others), or can be generated by the To-Do list module 42 via reference to the situation assessor 48, the machine learning module 52, etc., and continuously generated.

The To-Do list module 42 is adapted to evaluate environmental needs relative to the itemized To-Do list database 150. In particular, the To-Do list module 42 is adapted to evaluate whether something in the actor's environment 30 requires attention or maintenance. The To-Do list module 42 can compares events or non-events, as determined by the situation assessor 48 relative to a particular item in the actor's environment 30, with information in the environmental requirements database 152 to determine whether the current status of that item does not conform with expected “standards” provided by the environmental requirements database 152. For example, the environmental database 152 can include a designation that all light bulbs in the actor's environment 30 must be operational. Upon receiving information from the situation assessor 48 that a particular light bulb has burned out and comparing this with the environmental expectation that all light bulbs must be operational, the To-Do list module 42 will determine that the burned out light bulb requires attention.

Once a determination is made that a particular item in the environment 30 requires attention, the To-Do list module 42 is adapted to compare the identified item with the To-Do list database 150 and infer whether a new To-Do list item should be generated. In general terms, a newly identified environmental need could be added to the To-Do list database 150 if not already present in the To-Do list database 150. In a preferred embodiment, this decision is further based upon a context of the actor 28 and/or the environment 30, as otherwise determined by the situation assessor 48. For example, the situation assessor 48 may indicate that the actor's window screens are dirty. Upon reviewing the constraints stored in the environmental requirements database 152, the To-Do list module 42 determines that the window screens should be cleaned. The To-Do list module 42 further determines that this task is not currently stored in the To-Do list database 150, and thus considers generating a new To-Do list item for the database 150. However, because it is wintertime and screen cleaning is inadvisable, the To-Do list module 42 can determine, under these context circumstances, that the “clean window screens” task or item should not be added to the To-Do list database 150. This filtering of a static “To-Do” list item based on context represents a distinct advancement in the art.

In addition to generating new To-Do list items, the To-Do list module 42 is preferably adapted to signal the response planner 50 with information in the event an identified environmental need requires immediate attention, and a decision is made that adding the new To-Do list items to the To-Do list database 150 and/or displaying the new To-Do list items on the To-Do list presenter 154 likely will not prompt the actor 28 (or others) to immediately address the new To-Do list task. For example, based upon a machine learning built model of behavior, the To-Do list module 42 can learn that the actor 28 normally reviews To-Do list database 150/presenter 154 entries on a weekly basis. Upon generating a new To-Do list item of “replace battery in smoke alarm” and determining that this item requires immediate attention, the To-Do list module 42 infers that the actor 28 will not review this new To-Do list item for several days. As a result, the To-Do list module 42 prompts the response planner 50 to provide an appropriate instruction to the actor 28 or others, as previously described.

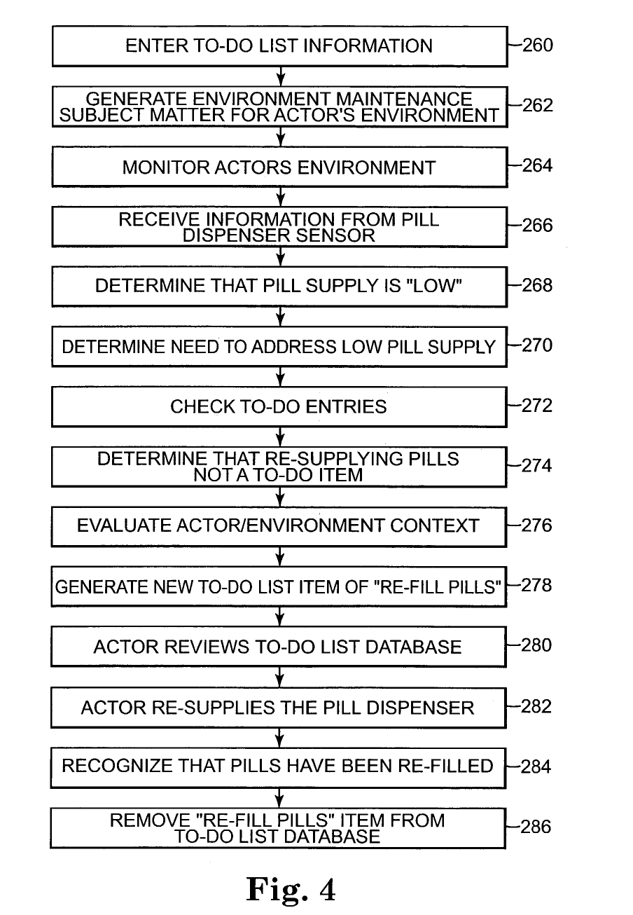

Operation of the To-Do list module 42 is best illustrated by the exemplary methodology provided in FIG. 4. As a point of reference, FIG. 4 relates to a scenario in which the actor 28 takes medication via a pill dispenser that otherwise includes a monitoring sensor that provides information indicative of the amount of pills contained within the dispenser. With this in mind, the methodology begins at step 260 whereby the system 20, including the To-Do list module 42, is installed and To-Do list information is entered into the To-Do list database 150. Once again, the To-Do list information preferably includes maintenance-type activities that will normally always occur in the actor's environment, along with a schedule of when a particular maintenance-type task should be completed. For example, the entered information can include replacing the furnace filter on a quarterly basis, purchasing groceries once per week, monthly doctor check-ups, etc.

Environmental constraints, requirements and expectations information or subject matter for the actor 28 and/or the actor's environment 30, not otherwise specified in the itemized To-Do list database 150, are and stored in the environmental requirements database 152 generated at step 262. Once again, this information can be predetermined and/or or can be generated over time (e.g., machine learning as previously described). With respect to the one example of FIG. 4, an environmental constraint of “re-supplying the pill dispenser when less than 25% full” is stored in the environmental requirements database 152.

At step 264, the situation assessor 48 monitors activities/events in the actor's environment 30 (via the activity monitor 46). The monitored activities/events can be item-specific (e.g., monitor all light bulbs) or can simply relate to all signaled information occurring within the environment 30. Regardless, at step 266, information from the pill dispenser sensor is provided to the situation assessor 48. At step 268, the situation assessor 48 determines that the supply level of the pill dispenser is less than 25% of full. The To-Do list module 42, at step 270, compares this information with the constraints set forth in the environmental requirements database 152 and determines that the “low” pill supply needs to be addressed.

At step 272, the To-Do list module 42 ascertains whether “low pill supply” is part of the itemized To-Do list database 150. At step 274, the To-Do list module 42 determines that re-supplying the pill dispenser is currently not a required To-Do list item.

The To-Do list module 42, at step 276 evaluates a context of the actor 28 and the environment 30 relative to the “low” pill supply situation. The To-Do list module 42 does not identify any factors that might otherwise make it inappropriate to generate a new To-Do list item of “re-fill pills”. As such, at step 278, the To-Do list module 42 generates the new To-Do list item that is added to the To-Do list database 150 and displayed to the actor via the To-Do list presenter 154.

The actor 28 reviews the To-Do list database 150 at step 280, and recognizes the “re-fill pills” requirement. At step 282, the actor 28 re-supplies the pills in the pill dispenser. At step 284, the situation assessor 48, based upon information from the activity monitor 46, recognizes that the pills have been re-supplied. The To-Do list module 42, in turn, automatically removes the “re-fill pills” item from the To-Do list database 150 (or otherwise designates that the To-Do list item has been completed) at step 286. In one preferred embodiment, the methodology of FIG. 4 is enhanced by machine learning that assists in establishing an appropriate interval to schedule a To-Do list item before critical (e.g., how empty should the pill bottle be before ordering more), or in a multi-person system, which person to assign a particular task or To-Do item.

C. Personal Reminder Module 44

Returning to FIG. 2, the system 20 preferably further includes the personal reminder module 44 that functions to evaluate desired personal activity reminders in the context of the actor's current activities/environment for optimizing the technique by which reminders are provided to the actor 28. The personal reminder module 44 interacts with the situation assessor 48 and the response planner 50 as previously described, as well as a personal activities model 170. In general terms, the personal reminder module 44 compares current state information generated by the situation assessor 48 with the activities stored in personal activities model 170 and determines that a particular activity relative to the person of the actor 28 needs to be performed (e.g., toileting within a certain time after eating, eating at certain times of the day, taking medication at certain times of the day, dressing after waking up in the morning, walking the dog after the dog eats, etc.). Upon determining that a designated personal activity should be carried out, the personal reminder module 44 infers whether or not a reminder should be given to the actor 28 to perform the particular activity. In a preferred embodiment, the reminder module 44 bases this decision upon the current environmental context of the actor 28. If appropriate, the personal reminder module 44 prompts the response planner 50 to generate the reminder in a most appropriate fashion. In a preferred embodiment, the personal reminder module 44 further operates to, via the situation assessor 48, monitor the actor 28 and confirm whether or not a particular required personal activity has been carried out. Similar to previous embodiments, two or more of the components can be combined into a single module or agent that is adapted to perform each of the assigned functions.

Much like the databases previously described, information in the personal activities model 170 is preferably entered and stored by the actor 28 and/or another person concerned with the actor's 28 well-being (e.g., caregiver, system installer, etc.). For example, the personal activities model 170 can include the designation that the actor 28 must attempt to use the toilet one hour after eating. Additionally, and in one preferred embodiment, information stored in the personal activities 170 is supplemented by the reminder module 44, in conjunction with other components, such as the machine learning module 52 (e.g., over time, the personal reminder module 44 may recognize that the actor 28 fails to floss after brushing his/her teeth; this “floss after brushing” personal activity can then be stored in the personal activities model 170).

The personal reminder module 44 is adapted to utilize the information stored in the personal activities model 170 to determine whether the actor 28 is in a situation (as otherwise designated by the situation assessor 48) that may require a personal reminder. For example, the personal activities model 170 can include an entry for flossing teeth after brushing; upon receiving information from the situation assessor 48 indicative of the actor 28 brushing his/her teeth, the personal reminder module 44 would then determine that the possibility for providing a “floss teeth” reminder has been indicated. Alternatively, a higher level of abstraction can be incorporated into the personal reminder module 44 for evaluating whether an entry in the personal activities model 170 has been indicated by the information generated by the situation assessor 48.

The personal reminder module 44 is further adapted, upon recognizing the initiation of an activity found in the personal activities model 170, to decide whether or not the one or more event items associated with that particular activity have been completed based upon actor monitoring information provided by the situation assessor 48. With continued reference to the above example of whereby the situation assessor 48 indicates that the actor 28 is brushing his/her teeth and the personal activities model 170 recites that the actor 28 should then floss, the personal reminder module 44 will monitor the actor's 28 further activities (via the situation assessor 48), to determine whether or not the actor 28 has flossed. To this end, the personal reminder module 44 can be adapted to utilize a variety of techniques for deciding that the actor 28 has failed to perform a particular activity (e.g., failed to floss), including a threshold time value (e.g., if the situation assessor 48 does not indicate that the actor 28 has begun flossing within five minutes of brushing teeth, the personal reminder module 44 designates that the “floss teeth” activity has not been performed); based upon an indication that the actor 28 is engaged in another, unrelated activity (e.g., if the situation assessor 48 indicates that the actor 28 has moved to the bedroom shortly after brushing teeth, the personal reminder module 44 designates that the “floss teeth” activity has not been performed); etc.

Once a decision has been made that a required activity has not been performed, the personal reminder module 44 is adapted to determine whether a reminder to the actor 28 should be generated or suppressed. The personal reminder module 44 preferably bases this decision upon the current environmental context of the actor 28, as indicated by the situation assessor 48. For example, where the personal reminder module 44 determines that a need exists for reminding the actor 28 to eat at a certain time of day, but that a utensil drawer in the actor's kitchen has recently been opened, the personal reminder module 44 will infer that no reminder is necessary (i.e., the requisite reminder will be suppressed) as it appears that the actor 28 is in the process of preparing a meal. Other context-related factors can be incorporated into this decision of whether to generate or suppress the reminder, such as persons in the room, time of day, etc. Further, the personal reminder module 44 is preferably adapted to determine whether additional reminders for a particular personal activity are required (e.g., in the event the actor 28 does not act upon a first reminder). In this regard, the machine learning module 52 preferably is incorporated to assist in determining the frequency of reminding for un-completed activities.

An additional, preferred context-based feature of the personal reminder module 44 resides in the type of reminder generated. For example, where the particular personal activity relates to reminding the actor 28 to wash his/her hair at a certain time of day, and it is determined that the actor 28 currently has guests, the personal reminder module 44 will recognize that announcing over a speaker system “wash your hair” is inappropriate; the personal reminder module 44 could instead instruct the actor 28 to go to a user interface device in a separate room to provide the reminder. Similarly, the personal reminder module 44 is preferably adapted to utilize context information from the situation assessor 48 to determine most opportune times to generate a reminder, even in advance of a threshold time for the reminder where appropriate. For example, the personal activities model 170 may include an entry of “feed dog at 5:00 p.m.”; at 4:55 p.m., the situation assessor 48 informs the personal reminder module 44 that the actor 28 is in the laundry room where the dog's dish is located. The personal reminder module 44 preferably recognizes that the “feed dog” reminder will be required in five minutes; rather than have the actor 28 make another trip to the laundry room, the personal reminder module 44 decides that it is more appropriate to generate the reminder immediately. Similarly, the personal reminder module 44 may be informed (such as via the situation assessor 28) that the actor's 28 favorite television show begins at 5:00 p.m. Under these circumstances, the personal reminder module 44 may device that it is more appropriate to provide the “feed dog” reminder shortly before 5:00 p.m.

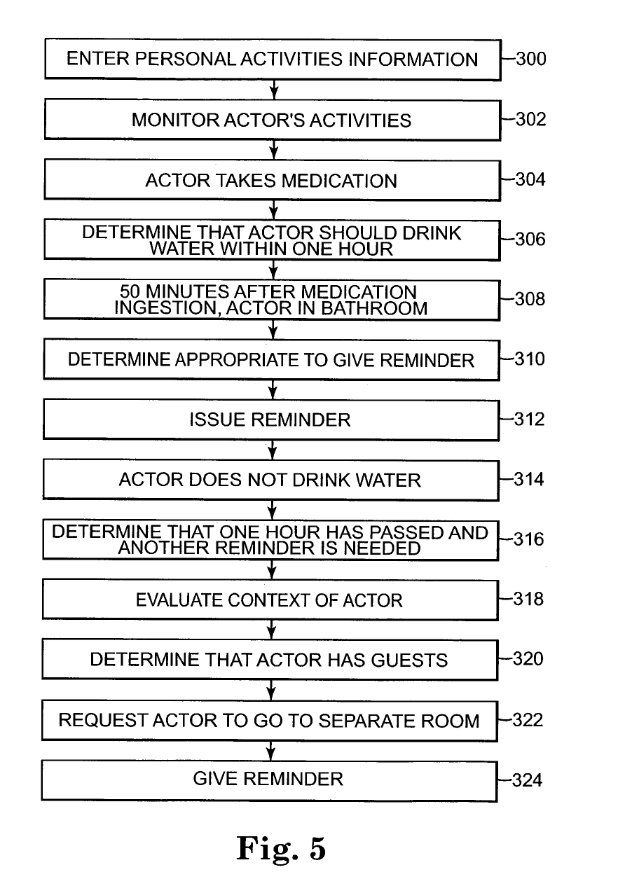

Operation of the personal reminder module 44 is best illustrated by the exemplary scenario provided in FIG. 5. Beginning at step 300, various personal reminder activity information is entered into the personal activities model 170. Once again, the types of activities or tasks that might otherwise require actor reminders can vary for individual situations. With respect to the example of FIG. 5, one personal activity is drinking a glass of water after taking a particular medication.

At step 302, the situation assessor 48 monitors the actor's 28 actions (via the activity monitor 46). In this regard, and at step 304, the situation assessor 48 provides the personal reminder module 44 with information indicative of the actor 28 taking the particular medication. Upon reference to the personal activities model 170, then, the personal reminder module 44 determines, at step 306, that the actor 28 should drink a glass of water within the next hour.

Fifty minutes after the actor 28 ingested the medication, the situation assessor 48, via the activity monitor 46, determines that the actor 28 has entered the bathroom and used the toilet (referenced generally at step 308). The personal reminder module 44 recognizes that the “drink glass of water” reminder will be issued within the next ten minutes; however, because the actor 28 is in the bathroom (and thus in close proximity to a source of water) determines that it would be more appropriate to issue the reminder to drink water now so that the actor 28 is not required to make a second trip (generally referenced at step 310). At step 312, the personal reminder module 44 forwards the issue reminder request to the response planner 50 that, in turn, determines that the most appropriate technique for reminding the actor 28 is to display a text reminder on a bathroom web pad. At step 314, the personal reminder module 44 determines, based upon information from the situation assessor 48, that the actor 28 did not drink a glass of water while in the bathroom.

Ten minutes later, at step 316, the personal reminder module 44 determines that, via information from the situation assessor 48, one hour has passed since the medication was taken, and thus, based upon the personal activities model 170, that another reminder should be generated again to the actor 28. At step 318, the personal reminder module 44 evaluates a current context of the actor 28 via reference to information generated by the situation assessor 48. In particular, the personal reminder module 44 is informed that, or determines at step 320 that the actor 28 is in a separate room with several guests. As such, the personal reminder module 44 determines that it would be inappropriate to issue a reminder to the actor 28 in front of his/her guests, and instead designates that the reminder should be issued to the actor 28 in private. In particular, the personal reminder module 44 and/or the response planner 50 determines, that the most appropriate technique for reminding the actor 28 is to display a text reminder on a bathroom web pad and to request that the actor 28 go to a web pad in a separate room. With this in mind, at step 322, the personal reminder module 44 requests the response planner 50 to prompt a speaker system associated with the system 20 (FIG. 1) to request that the actor 28 go to a web pad in a separate room. Upon learning that the actor 28 has accessed this separate web pad, the reminder is again presented to the actor 28 at step 324.

As should be evidenced from the above example, the preferred personal reminder module 44 is capable of providing actor reminders that are not otherwise purely schedule-based, but instead can react to the activities/needs of the actor, remaining cognizant of the actor's current situation.

The condition-based activity prompting system and method of the present invention provides a marked improvement over previous designs. In particular, the system and method of present invention is capable of automatically monitoring the actor's status, activities, and environment; inferring needs of the actor and/or their environment; and automatically generating intelligent reminders, To-Do lists, and task instructions.

Although the present invention has been described with reference to preferred embodiments, workers skilled in the art will recognize that changes can be made in form and detail without departing from the spirit and scope of the present invention.

What is claimed is:

1. A system for automatically generating a task prompt to an actor comprising:
a controller; and
at least one sensor for monitoring the actor;
wherein the controller is adapted to receive sensor data from the sensor, determine if the actor has initiated a particular task based upon a comparison of the sensor data to predefined task data, determine if the actor requires assistance with the particular task, and generate a prompt if the actor requires assistance with the particular task.

2. The system of claim 1, further comprising:
a plurality of sensors each providing sensor data to the controller, the plurality of sensors including a first sensor adapted to generate sensor data relating to actions of the actor and a second sensor adapted to generate sensor data relating to actions in an environment of the actor.

3. The system of claim 1, further comprising:
a machine learning module adapted to generate information relating to one of optimizing and adapting functioning of the controller in generating a task prompt.

4. The system of claim 1, wherein the predefined task data comprises a task instruction database including task instructions for at least the particular task.

5. The system of claim 1, wherein the controller is further adapted to determine an environmental context of the actor.

6. The system of claim 5, wherein the controller is further adapted to determine whether a prompt should be provided based upon the environmental context of the actor.

7. The system of claim 1, wherein the controller is further adapted to confirm completion of a step associated with the particular task.

8. The system of claim 1, further comprising:
an interaction device connected to the controller and adapted to provide the prompt to the actor.

9. The system of claim 1, wherein the particular task relates to a daily activity of the actor.

10. The system of claim 1, wherein the system is adapted to operate in a home of the actor.

11. A method for automatically generating a task prompt to an actor, the method comprising:
monitoring actions of an actor;
determining whether the actor has initiated a particular task;
determining whether the actor requires assistance in completing the particular task based upon a task database and the monitored actions of the actor; and
providing a prompt to the actor if the actor requires assistance.

12. The method of claim 11, the method further comprising:
determining an environmental context of the actor.

13. The method of claim 12, the method further comprising:
providing the prompt to the actor based upon the environmental context of the actor.

14. The method of claim 11, the method further comprising:
determining whether a step associated with the particular task has been completed.

15. The method of claim 11, wherein monitoring actions of an actor comprises monitoring actions of an actor using at least one of an intrusive and non-intrusive sensor.

16. The method of claim 11, the method further comprising:
learning a behavior of the actor for modifying a task in the task database.

17. The method of claim 11, the method further comprising:
learning a behavior of the actor for adding a task to the task database.

18. The method of claim 11, wherein the particular task relates to a daily activity of the actor.

19. The method of claim 11, further comprising:
providing a situation assessor for determining whether the actor has initiated a particular task.

20. The method of claim 11, wherein the actor is located in a home of the actor.

21. A system for automatically generating a reminder prompt to an actor, comprising:
a controller; and
at least one sensor for monitoring the actor;
wherein the controller is adapted to receive sensor data from the sensor and determine whether a reminder should be provided to the actor based upon a comparison of the sensor data to predefined personal activities data.

22. The system of claim 21, further comprising:
a plurality of sensors for monitoring the actor, wherein the controller receives sensor data from each of the plurality of sensors.

23. The system of claim 21, wherein the controller is further adapted to determine an environmental context of the actor.

24. The system of claim 23, wherein the controller is further adapted to determine whether to provide the reminder based upon the environmental context of the actor.

25. The system of claim 21, wherein the controller is further adapted to determine whether an activity associated with a reminder provided to the actor has been completed.

26. The system of claim 21, wherein the predefined personal activities data comprises a threshold time for an activity associated with a reminder to be performed and the controller is further adapted to determine whether to provide the reminder to the actor in advance of the threshold time.

27. The system of claim 21, further comprising:
an interaction device connected to the controller and adapted to provide the reminder to the actor.

28. The system of claim 21, wherein the reminder relates to a daily activity of the actor.

29. The system of claim 21, wherein the predefined personal activities data is stored in a database.

30. The system of claim 21, wherein the system is adapted to operate in a home of the actor.

31. A method for automatically generating a reminder prompt to an actor, the method comprising:
monitoring activities of an actor;
referencing predefined personal activities data;
determining that a particular reminder is indicated by the predefined personal activities data; and
determining whether to provide a reminder prompt to the actor based upon the monitored activities of the actor.

32. The method of claim 31, the method further comprising:
determining an environmental context of the actor.

33. The method of claim 31, wherein monitoring activities of an actor comprises monitoring at least one of a physiological or physical activity of the actor.

34. The method of claim 32, the method further comprising:
determining a most opportune time to provide a reminder prompt based upon the environmental context of the actor.

35. The method of claim 31, the method further comprising:
determining whether an activity associated with the particular reminder has been completed.

36. The method of claim 31, the method further comprising:
determining a format for a reminder prompt to the actor.

37. The method of claim 31, the method further comprising:
determining if an additional reminder prompt needs to be provided to the actor.

38. The method of claim 31, wherein the particular reminder relates to a daily activity of the actor.

39. The method of claim 31, wherein the predefined personal activities data is stored in a database.

40. The method of claim 31, wherein the actor is located in a home of the actor.

41. A system for automatically generating a to-do list for an actor in an environment, comprising:
a controller; and
at least one sensor for generating state data relating to the environment of an actor;
wherein the controller is adapted to receive state data from the sensor, compare the state data to expected state data, and determine whether to generate a to-do list item based upon the comparison.

42. The system of claim 41, further comprising:
an environmental requirements database for storing expected state data for the environment of the actor.

43. The system of claim 41, further comprising:
an interaction device adapted to provide the to-do list item to the actor.

44. The system of claim 41, wherein the controller is further adapted to determine whether a to-do list item has been completed based upon the state data from the sensor.

45. The system of claim 41, wherein the controller is further adapted to distinguish a to-do list item that requires immediate attention of the actor from a to-do list item that does not require immediate attention of the actor.

46. The system of claim 41, further comprising:
a machine learning module adapted to generate information relating to one of optimizing and adapting functioning of the controller in generating a to-do list.

47. The system of claim 41, further comprising:
a to-do list database including the expected state data.

48. The system of claim 41, wherein the to-do list item relates to a daily activity of the actor.

49. The system of claim 41, wherein the to-do list item relates to home maintenance.

50. The system of claim 41, wherein the system is adapted to operate in a home of the actor.

51. A method for automatically generating a to-do list, the method comprising:
monitoring an environment of an actor and obtaining a monitored state;
comparing the monitored state to an expected state; and
determining whether a to-do list item needs to be generated based upon a comparison of the monitored state and the expected state.

52. The method of claim 51, the method further comprising:
providing the to-do list item to the actor.

53. The method of claim 51, the method further comprising:
determining whether a to-do list item has been completed.

54. The method of claim 51, the method further comprising:
storing the to-do list item in a database.

55. The method of claim 51, further comprising:
referencing an environmental requirements database to determine the expected state.

56. The method of claim 51, further comprising:
referencing a to-do list database to determine the expected state.

57. The method of claim 51, the method further comprising:
learning a behavior of the actor to generate the expected state.

58. The method of claim 51, wherein the to-do list item relates to a daily activity of the actor.

59. The method of claim 51, wherein the to-do list item relates to home maintenance.

60. The method of claim 51, wherein the actor is located in a home of the actor.
